(19) United States
(12) Patent Application Publication
(10) Pub. No.: US 2025/0056457 A1
(43) Pub. Date: Feb. 13, 2025

(54) METHOD AND APPARATUS FOR IMPROVED DETERMINATION OF TIMING ADVANCES

(71) Applicant: Nokia Technologies Oy, Espoo (FI)

(72) Inventors: Umur KARABULUT, Munich (DE); Anastasios KAKKAVAS, Munich (DE); Sanjay GOYAL, Murray Hill, NJ (US); Ali KARIMIDEHKORDI, Munich (DE); Panagiotis SPAPIS, Munich (DE)

(21) Appl. No.: 18/793,283

(22) Filed: Aug. 2, 2024

Related U.S. Application Data
(60) Provisional application No. 63/519,026, filed on Aug. 11, 2023.

(51) Int. Cl. H04W 56/00

(52) U.S. Cl. CPC H04W 56/0045; H04W 56/001

(57) ABSTRACT

A user equipment (UE) may receive, from a first network entity, an indication of a configuration for the UE to report, to the first network entity, an estimate of a first timing advance value for a second network entity. The UE may determine the estimate of the first timing advance value. The UE may transmit, to the first network entity, the estimate of the first timing advance value for the second network entity or a reference signal time difference associated with the estimate of the first timing advance value. The UE may receive, from the first network entity, an indication of an error value associated with the estimate of the first timing advance value. The UE may determine a second timing advance value based on the estimate of the first timing advance value and the error value. The UE may transmit communications using the second timing advance value.

### TECHNOLOGICAL FIELD

An example embodiment relates generally to wireless communications and, more particularly, but not exclusively, to a method, apparatus and computer program product for improved determination of timing advances.

### BACKGROUND

Some wireless devices may be configured to perform various operations to support user equipment (UE) mobility within a wireless communications system. For example, when a UE moves from a coverage area of a first cell (e.g., a first distributed unit (DU)) to a coverage area of a second cell (e.g., a second distributed unit (DU)), a serving cell change may be performed. For example, the serving cell of the UE may be switched from the first cell to the second cell. Currently serving cell changes (e.g., handovers) utilize multiple types of Layer 3 (L3) signaling, such as radio resource control (RRC) signaling. For example, radio resource control (RRC) measurements may trigger a serving cell change (e.g., if a value of an RRC measurement satisfies a threshold) and downlink RRC signaling may be utilized for serving cell change commands or to otherwise indicate a serving cell change. In some cases, an RRC reconfiguration message may indicate or otherwise trigger a change of a primary cell (PCell) and a primary secondary cell (PSCell). Additionally, or alternatively, an RRC reconfiguration message may indicate or otherwise trigger release and addition of secondary cells (SCells). All cases may involve complete Layer 2 (L2) and Layer 1 (L1) resets, leading to longer latency, larger overhead, and longer interruption time when compared to similar processes for beam switch mobility. Accordingly, some L1/L2 mobility enhancements that enable a serving cell change via L1/L2 signaling, may reduce the latency, overhead, and interruption time when compared to serving cell changes via L3 signaling.

FIG. 1 illustrates an example of a signal flow diagram 100 that illustrates techniques for L1/L2 triggered mobility (LTM). The signal flow diagram 100 may include a UE 105 and a base station 110, which may perform the operations described herein. In some cases, the base station 110 may include one or more DUs and one or more centralized units (CUs). The flow diagram 100 may provide one illustrative example of an order or sequencing for the operations described herein, however, any order or sequencing may be used. In some cases, one or more operations of the signal flow diagram 100 may not be performed or may otherwise be omitted. Additionally, or alternatively, the UE 105 and the base station 110 may perform operations that are not shown in the signal flow diagram 100.

The signal flow diagram 100 may be an example of a message sequence chart (MSC) for LTM, which may be based on a change request for the LTM framework. The signal flow diagram 100 may include one or more phases, such as a preparation phase (e.g., an LTM preparation phase), a synchronization phase (e.g., an early sync phase), an execution phase (e.g., an LTM execution phase), and a completion phase (e.g., an LTM completion phase). Each phase may include one or more operations (e.g., one or more communications), as shown.

At 115, the UE 105 may be in an RRC connected state. For example, an RRC connection between the UE 105 and the base station 110 may have previously been established. At 120, the UE 105 may transmit (e.g., cause transmission of) a measurement report (e.g., an RRC measurement report) to (e.g., towards) the base station 110. At 125, the base station 110 (e.g., a CU of the base station 110) may prepare one or more target cells (e.g., one or more DUs of the base station 110, one or more DUs of a different base station) for LTM. At 130, the base station 110 (e.g., a CU of the base station 110) may provide an LTM configuration for one or more prepared cells. For example, the base station 110 may transmit the LTM configuration for the one or more prepared cells to the UE 105. Additionally, or alternatively, the base station 110 may configure the UE 105 with L1 measurement reported for LTM execution.

At 135, the UE 105 may transmit an RRC configuration message to the base station 110. The RRC configuration message may indicate that the RRC configuration is complete. At 140, the UE 105 may perform uplink (UL) and downlink (DL) synchronization (e.g., early UL/DL synchronization) with candidate cells, which may minimize or eliminate interruptions during LTM execution. Limiting interruptions may be an example of a key advantage of LTM when compared to other handover procedures. For example, handover procedures that utilize L3 signaling may involve interruptions caused by synchronization processes with target cells.

At 145, the UE 105 may transmit one or more L1 measurements (e.g., beam measurements) for target cells to the base station 110 (e.g., to the source cell) and a DU of the base station 110 may determine which cell the UE 105 should switch to (e.g., handover to). At 150, the base station 110 may determine which cell the UE 105 should switch to. At 155, the base station 110 may transmit a cell switch command to the UE 105. In some cases, the cell switch command may be communication via medium access control control element (MAC-CE) signaling. At 160, the UE 105 may detach from a source (e.g., a source cell) and apply one or more configurations for a target (e.g., a target cell). For example, the UE 105 may disconnect from a first serving cell and establish a connection with a second serving cell.

At 165, the UE 105 may perform a random-access channel (RACH) procedure. The RACH procedure may be for establishing a connection with the second serving cell (e.g., the target serving cell). In some cases, the UE 105 may not perform the RACH procedure. For example, the UE 105 may not perform the RACH procedure if a timing advance (TA) of the target serving cell is still valid (e.g., from the DL/UL synchronization performed at 140). At 170, the LTM procedure may be complete. For example, the UE 105 may have successfully established a connection with the target serving cell and the LTM procedure may be terminated.

FIG. 2 illustrates an example of a signal flow diagram 200 that illustrates techniques for L1/L2 triggered mobility (LTM). The signal flow diagram 100 may include a UE 105, which may be an example of a corresponding UE 105, as described with reference to FIG. 1. The signal flow diagram 100 may also include a DU 201-a, a DU 201-b, and a CU 203. The DUs 201 and the CU 203 may be components or virtualized entities of a base station 110, as described with reference to FIG. 1. The UE 105, the DUs 201, and the CU 203 may perform the operations described herein. The flow diagram 200 may provide one illustrative example of an order or sequencing for the operations described herein, however, any order or sequencing may be used. In some cases, one or more operations of the signal flow diagram 100 may not be performed or may otherwise be omitted. Additionally, or alternatively, the UE 105, the DU 201-a, the DU 201-b, and the CU 203 may perform operations that are not shown in the signal flow diagram 100. As described herein, the signal flow diagram 200 may be a more detailed example of the LTM framework described with reference to FIG. 1. For example, the LTM framework described with reference to FIG. 1 may not show details related to the split architecture for a base station 110 (e.g., DUs 201 and the CU 203) and may instead include more general descriptions of the overall radio access network (RAN).

For the LTM preparation phase (e.g., from 205 to 223), the CU 203 provides the LTM configuration for prepared cells (e.g., prepared DUs 201). Additionally, or alternatively, the CU 203 configures the UE 105 with L1 measurement reporting for LTM execution. Additionally, or alternatively, the CU 203 provides the TA acquisition triggering criteria and associated configurations to the source DU (e.g., the DU 201-a). Additionally, or alternatively, the CU 203 provides the cell switch triggering criteria and necessary configurations to the DU 201-a. The triggering criteria of TA acquisition and cell switch can be similar to measurement event report triggering conditions or validity of acquired TAs. In some cases, triggering configurations may filter configurations (for L1 measurements), trigger offsets, cell individual offsets, or the like.

At 205, the UE 105 may transmit a measurement report (e.g., an L3 measurement report) to the DU 201-a (e.g., a source DU, a source cell). At 207, the DU 201-a may transmit a measurement report to the CU 203. For example, the DU 201-a may transmit an L3 measurement report to the CU 203. Additionally, or alternatively, the DU 201-a may transmit an RRC message to the CU 203. The RRC message may be an UL RRC message. In some cases, the RRC message may include the measurement report. At 209, the CU 203 may determine (e.g., select) one or more target cells (e.g., the DU 201-b) to prepare for LTM.

At 211, the CU 203 may transmit a UE context setup request to the DU 201-b. Additionally, or alternatively, the CU 203 may receive a UE context setup response from the DU 201-b. At 213, the CU 203 may transmit a UE context modification request to the DU 201-a. Additionally, or alternatively, the CU 203 may receive a UE context modification response from the DU 201-a. At 215, the CU 203 may generate one or more RRC configurations (e.g., one or more RRC reconfigurations). The one or more RRC configurations may include a measurement configuration of an L1 cell change and a configuration of prepared cells. At 217, the CU 203 may transmit (e.g., transfer) an RRC message (e.g., a DL RRC message) to the DU 201-a. The RRC message may include one or more TA acquisition criteria, one or more cell switch criteria, or both.

At 219, the DU 201-a may transmit an RRC reconfiguration to the UE 105. At 221, the UE 105 may transmit an indication to the DU 201-a that the RRC reconfiguration is complete. At 223, the DU 201-a may transmit (e.g., transfer) an RRC message (e.g., an UL RRC message) to the CU 203. At 225, the UE 105 may transmit an L1 measurement report to the DU 201-a. At 227, the DU 201-a may trigger or determine to trigger a TA acquisition for a target cell (e.g., for the DU 201-b). At 229, the DU 201-a may transmit a TA acquisition command to the UE 105.

At 231, the UE 105 may transmit a random-access preamble to the DU 201-b. The UE 105 may transmit the random-access preamble so that the DU 201-b (e.g., the target DU) may estimate a TA between the UE 105 and the DU 201-b. At 233, the DU 201-b may transmit a random-access response. The DU 201-b may transmit the random-access response to the CU 203 and to the DU 201-a. In some cases, the CU 203 may receive the random-access response and may retransmit the random-access response to the DU 201-a. In some cases, the DU 201-a may transmit the random-access response to the UE 105.

At 235, the UE 105 may transmit one or more L1 measurement reports to the DU 201-a. The one or more L1 measurement reports may include one or more beam measurement reports for prepared target cells (e.g., target DUs). At 237, the DU 201-a may determine a serving cell change. For example, the DU 201-a may determine to trigger a serving cell change and transfer the UE 105 to the DU 201-b. In some cases, the DU 201-a may determine a serving cell (e.g., for handover) based on the one or more L1 measurement reports. At 239, the DU 201-a may trigger the serving cell change. In some cases, the DU 201-a may trigger the serving cell change using a MAC-CE command. Additionally, or alternatively, the DU 201-a may transmit a TA for the target cell (e.g., the DU 201-b) to the UE 105. The DU 201-a may transmit the TA (e.g., in the MAC-CE command) if the random-access response is not received by the UE 105 (e.g., at 233).

At 241, the UE 105 and the DU 201-b may perform a random-access procedure. For example, the UE 105 may transmit one or more random access requests to the DU 201-b. If the TA of a target cell (e.g., the DU 201-b) is valid, the UE 105 may skip (e.g., refrain from performing) the random-access procedure. At 243, the UE 105 and the DU 201-b may complete the RRC configuration. At 245, the DU 201-b may transmit an UL RRC message to the CU 203. At 247, the CU 203 may transmit a context release command (e.g., for the UE context information) to the DU 201-a. At 249, the DU 201-a may transmit a context release complete (message) (e.g., for the UE context information) to the CU 203.

FIG. 3 illustrates an example of a timing diagram 300. The timing diagram 300 may illustrate signaling between a UE 105, a TRP 305-a, and a TRP 305-b. The TRPs 305 may be examples of base stations 110 or respective DUs of the base station 110, as described with reference to FIGS. 1 and 2. As shown, a first distance, D1, between the TRP 305-a and the UE 105 may be lesser than a second distance, D2, between the TRP 305-b and the UE 105. Accordingly, a relative time difference, RTD, may exist between a time that the UE 105 receives a first DL transmission from the TRP 305-a and a second DL transmission from the TRP 305-b.

In some cases, a UE 105 may be capable of acquiring a TA for a transmit/receive point (TRP) 305 without a random-access procedure (e.g., without random-access signaling). As described herein, UE-based TA acquisition (e.g., without random-access signaling) is one method for early TA acquisition. As shown, FIG. 3 provides examples of UE-based TA acquisition when the UE 105 calculates the TA of the TRP 305-b while it is served by the TRP 305-a. The TA for the TRP 305-b (TA2) may be calculated using equation (1), shown below.

$$TA 2 = TA 1 + 2 RTD - 2 Realized ( TAE ) - OtherEstError \qquad ( 1 )$$

In equation (1), TA1 is the TA for the TRP 305-a, RTD is the relative time difference in time of transmission of simultaneous signals transmitted by any pair of TRPs (e.g., TRP 305-a and the TRP 305-b), Realized(TAE) is the realized timing alignment error and OtherEstError includes any error that can be caused by UL/DL reciprocity or estimator implementation/method error. TAE is defined in 38.104, Sec. 6.5.3, in the context of multiple-input-multiple-output (MIMO) transmissions from a TRP 305, with the maximum value not exceeding 3000 ns and an extension of the definition for LTM being under discussion in 3GPP. A similar quantity, named cell phase synchronization accuracy, pertaining to transmissions from a pair of cells is defined in 38.133, Sec. 7.4. Cell phase synchronization accuracy for time division duplexing (TDD) is defined as the maximum absolute deviation in frame start timing between any pair of cells on the same frequency that have overlapping coverage areas. According to some protocols for wireless communications, a minimum threshold cell phase synchronization accuracy may be defined as 3000 nanoseconds (ns).

In the context of DL positioning, a transmission timing error may be defined in 38.305, Sec. 3.1 as the result of transmission time delay involved in the transmission of a signal, which may in turn be defined as the time delay from the time when the digital signal is generated at baseband to the time when the RF signal is transmitted from the Tx antenna. In addition, in 37.355, the information element NR-RTD-Info may be used by the location server to provide time synchronization information between a reference TRP 305 and a list of neighbor TRPs 305. These definitions, information elements, and relevant mechanisms in the specification may enable the UE 105 to become aware of timing misalignments in the transmissions from different TRPs 305 and take them into account in position estimation.

As described herein, two methods for early TA acquisition may be utilized (e.g., UE-based TA estimation and RACH-based TA acquisition). In some cases, UE-based TA estimation may enable a UE 105 to estimate the TA of a target cell without requiring any RACH procedure. For example, the UE may facilitate determining of TA from existing DL measurements, thereby avoiding any additional signaling costs. This may prevent the UE 105 from experiencing any interruption due to RACH procedures (e.g., each PRACH preamble transmission towards the target cell may be subject to interruption between the UE 105 and the serving cell). Additionally, TA validity may not present significant challenges because the UE 105 may continue to estimate the TA along with its mobility, which may reduce or eliminate TA invalidity issues.

On the other hand, the UE-based TA estimation may be subject to estimation error. When the reference signal time difference (RSTD) estimation error is large it may cause misalignment in uplink synchronization. For example, the UE-based TA estimation may not meet uplink timing requirements, which may lead to failure of the RACH-less procedure. Additionally, or alternatively, handover failure may occur. Such challenges may be relatively more pronounced in asynchronous scenario where the RSTD between the cells may be larger than a cyclic prefix (CP) and hence the estimation error may also be relatively large.

In some cases, RACH-based TA acquisition techniques may be relatively more precise than RACH-less techniques because RACH-based techniques determine TAs using UL channel transmissions and the evaluation may be performed at the target cell. Although RACH-based TA acquisition techniques provide greater accuracy when compared to RACH-less techniques, the TA is subject to validity for every millisecond (ms) that is not used by the UE 105 during mobility. In such cases, the network may need to re-trigger the TA acquisition of the UE 105 which may cause additional interruption for the UE 105 as well as signaling overhead both on the air interface and F1 interface.

### BRIEF SUMMARY

In one aspect, a method includes receiving, at a user equipment (UE), from a first network entity, an indication of a configuration for the UE to report, to the first network entity, an estimate of a first timing advance value or a reference signal time difference (RSTD) for a second network entity, determining, at the UE, the estimate of the first timing advance value based at least in part on receiving the indication of the configuration, causing transmission, towards the first network entity, of the estimate of the first timing advance value for the second network entity or the reference signal time difference associated with the estimate of the first timing advance value, receiving, from the first network entity, an indication of an error value associated with the estimate of the first timing advance value for the second network entity, determining a second timing advance value based at least in part on the estimate of the first timing advance value and the error value, and causing transmission, using the second timing advance value, towards the second network entity, of one or more communications.

In some cases, the configuration indicates that the UE is to report the estimate of the first timing advance value or the RSTD for the second network entity based at least in part on an availability of the second network entity. In some cases, where the configuration indicates that the UE is to report the estimate of the first timing advance value or an RSTD for the second network entity based at least in part on one or more conditions being satisfied. In some cases, the configuration indicates that the UE is to report the estimate of the first timing advance value or an RSTD for the second network entity based at least in part on one or more of (i) a change of a beam of the second network entity used for determining the estimate of the first timing advance value or (ii) a change of an SSB of the second network entity used for determining the estimate of the first timing advance value.

In one embodiment, the method may include causing transmission, towards the first network entity, of information associated with the second network entity, the information includes one or more of: (i) reference signal information for the second network entity, (ii) an identifier for the second network entity, or (iii) a carrier frequency for communications with the second network entity. In some cases, receiving the indication of the error value further includes receiving a medium access control control element (MAC-CE) from the first network entity includes the indication of the error value. Other technical features may be readily apparent to one skilled in the art from the following figures, descriptions, and claims.

In one aspect, a method includes causing transmission, by a first network entity and towards a user equipment (UE), of an indication of a configuration for the UE to report, to the first network entity, an estimate of a first timing advance value or an RSTD for a second network entity, receiving, from the UE, the estimate of the first timing advance value for the second network entity, determining, by the first network entity, an error value associated with the estimate of the first timing advance value, where the determining is based at least in part receiving the estimate of the first timing advance value, and causing transmission, towards the UE, of an indication of the error value associated with the estimate of the first timing advance value for the second network entity.

In an embodiment, the method may further include receiving, from the second network entity, a second timing advance value, where determining the error value based at least in part on a comparison of the first timing advance value and the second timing advance value. In some cases, the configuration indicates that the UE is to report the estimate of the first timing advance value or an RSTD for the second network entity based at least in part on an availability of the second network entity. In some cases, the configuration indicates that the UE is to report the estimate of the first timing advance value or an RSTD for the second network entity based at least in part on one or more conditions being satisfied.

In some cases, the configuration indicates that the UE is to report the estimate of the first timing advance value or an RSTD for the second network entity based at least in part on one or more of (i) a change of a beam of the second network entity used for determining the estimate of the first timing advance value or (ii) a change of an SSB of the second network entity used for determining the estimate of the first timing advance value. In an embodiment, the method may further include receiving, from the UE, information associated with the second network entity, the information includes one or more of: (i) reference signal information for the second network entity, (ii) an identifier for the second network entity, or (iii) a carrier frequency for communications with the second network entity.

In some cases, causing transmission of the indication of the error value further includes causing transmission, towards the UE, of a medium access control control element (MAC-CE) includes the indication of the error value. Other technical features may be readily apparent to one skilled in the art from the following figures, descriptions, and claims. In one aspect, a method includes receiving, at a user equipment (UE), from a first network entity, an indication of a configuration for the UE to report, to the first network entity, whether the UE has estimated a first timing advance value for a second network entity, determining, at the UE, the estimate of the first timing advance value based at least in part on receiving the indication of the configuration, causing transmission, towards the first network entity, of an indication of whether the UE has estimated the first timing advance value for the second network entity, receiving, from the first network entity, a second timing advance value, determining a third timing advance value based at least in part on the first timing advance value and the second timing advance value, and causing transmission, using the third timing advance value, towards the second network entity, of one or more communications.

In an embodiment, the method may further include determining an error value based at least in part on comparing the first timing advance value with the second timing advance value, where the UE determines the third timing advance value based at least in part on the error value. In some cases, the configuration further indicates that the UE is to report an identifier of the second network entity to the first network entity in an instance in which the UE has estimated the first timing advance value for the second network entity.

In some cases, the configuration further indicates that the UE is to perform one or more operations for determining the third timing advance value. In some cases, the configuration indicates that the UE is to report whether the UE has estimated a first timing advance value for the second network entity based at least in part on one or more conditions being satisfied. In some cases, the configuration indicates that the UE is to report whether the UE has estimated a first timing advance value for the second network entity based at least in part on one or more of (i) a change of a beam of the second network entity used for determining the estimate of the first timing advance value or (ii) a change of an SSB of the second network entity used for determining the estimate of the first timing advance value.

In some cases, the configuration indicates that the UE is to estimate the first timing advance value in an instance in which a fourth timing advance value for the first network entity is estimated by the UE. In an embodiment, the method may further include causing transmission, towards the first network entity, of information associated with the second network entity, the information includes one or more of: (i) reference signal information for the second network entity, (ii) an identifier for the second network entity, or (iii) a carrier frequency for communications with the second network entity. Other technical features may be readily apparent to one skilled in the art from the following figures, descriptions, and claims.

In one aspect, a method includes causing transmission, by a first network entity and towards a user equipment (UE), of an indication of a configuration for the UE to report, to the first network entity, whether the UE has estimated a first timing advance value for a second network entity, receiving, from the UE, an indication of whether the UE has estimated the first timing advance value for the second network entity, and causing transmission, towards the UE, of a second timing advance value, where causing the transmission is based at least in part on receiving the indication of whether the UE has estimated the first timing advance value.

In some cases, the configuration further indicates that the UE is to report an identifier of the second network entity to the first network entity in an instance in which the UE has estimated the first timing advance value for the second network entity. In some cases, the configuration further indicates that the UE is to perform one or more operations for determining the third timing advance value. In some cases, the configuration indicates that the UE is to report whether the UE has estimated a first timing advance value for the second network entity based at least in part on one or more conditions being satisfied.

In some cases, the configuration indicates that the UE is to report whether the UE has estimated a first timing advance value for the second network entity based at least in part on one or more of (i) a change of a beam of the second network entity used for determining the estimate of the first timing advance value or (ii) a change of an SSB of the second network entity used for determining the estimate of the first timing advance value. In an embodiment, the method may further include receiving, from the UE, information associated with the second network entity, the information includes one or more of: (i) reference signal information for the second network entity, (ii) an identifier for the second network entity, or (iii) a carrier frequency for communications with the second network entity. Other technical features may be readily apparent to one skilled in the art from the following figures, descriptions, and claims.

In one aspect, a computing apparatus includes a processor. The computing apparatus also includes a memory storing instructions that, when executed by the processor, configure the apparatus to receive, at a user equipment (UE), from a first network entity, an indication of a configuration for the UE to report, to the first network entity, an estimate of a first timing advance value or an RSTD for a second network entity, determine, at the UE, the estimate of the first timing advance value based at least in part on receiving the indication of the configuration, cause transmission, towards the first network entity, of the estimate of the first timing advance value for the second network entity or a reference signal time difference associated with the estimate of the first timing advance value, receive, from the first network entity, an indication of an error value associated with the estimate of the first timing advance value for the second network entity, determine a second timing advance value based at least in part on the estimate of the first timing advance value and the error value, and cause transmission, using the second timing advance value, towards the second network entity, of one or more communications.

In some cases, the first timing advance value configuration indicates that the UE is to report the estimate of the first timing advance value for the second network entity based at least in part on an availability of the second network entity. In some cases, the first timing advance value configuration indicates that the UE is to report the estimate of the first timing advance value for the second network entity based at least in part on one or more conditions being satisfied. In some cases, the first timing advance value configuration indicates that the UE is to report the estimate of the first timing advance value for the second network entity based at least in part on one or more of (i) a change of a beam of the second network entity used for determining the estimate of the first timing advance value or (ii) a change of an SSB of the second network entity used for determining the estimate of the first timing advance value.

In some cases, the instructions further configure the apparatus to cause transmission, towards the first network entity, of information associated with the second network entity, the information includes one or more of: (i) reference signal information for the second network entity, (ii) an identifier for the second network entity, or (iii) a carrier frequency for communications with the second network entity. In some cases, the indication of the error value further includes receiving a medium access control control element (MAC-CE) from the first network entity includes the indication of the error value. Other technical features may be readily apparent to one skilled in the art from the following figures, descriptions, and claims.

In one aspect, a computing apparatus includes a processor. The computing apparatus also includes a memory storing instructions that, when executed by the processor, configure the apparatus to cause transmission, by a first network entity and towards a user equipment (UE), of an indication of a configuration for the UE to report, to the first network entity, an estimate of a first timing advance value or an RSTD for a second network entity, receive, from the UE, the estimate of the first timing advance value for the second network entity, determine, by the first network entity, an error value associated with the estimate of the first timing advance value, where the determining is based at least in part receiving the estimate of the first timing advance value, and cause transmission, towards the UE, of an indication of the error value associated with the estimate of the first timing advance value for the second network entity.

In some cases, the instructions further configure the apparatus to receive, from the second network entity, a second timing advance value, where determining the error value based at least in part on a comparison of the first timing advance value and the second timing advance value. In some cases, the first timing advance value configuration indicates that the UE is to report the estimate of the first timing advance value for the second network entity based at least in part on an availability of the second network entity. In some cases, the first timing advance value configuration indicates that the UE is to report the estimate of the first timing advance value for the second network entity based at least in part on one or more conditions being satisfied.

In some cases, the first timing advance value configuration indicates that the UE is to report the estimate of the first timing advance value for the second network entity based at least in part on one or more of (i) a change of a beam of the second network entity used for determining the estimate of the first timing advance value or (ii) a change of an SSB of the second network entity used for determining the estimate of the first timing advance value. In some cases, the instructions further configure the apparatus to receive, from the UE, information associated with the second network entity, the information includes one or more of: (i) reference signal information for the second network entity, (ii) an identifier for the second network entity, or (iii) a carrier frequency for communications with the second network entity.

In some cases, the instructions further configure the apparatus to cause transmission of the indication of the error value further includes causing transmission, towards the UE, of a medium access control control element (MAC-CE) includes the indication of the error value. Other technical features may be readily apparent to one skilled in the art from the following figures, descriptions, and claims. In one aspect, a computing apparatus includes a processor. The computing apparatus also includes a memory storing instructions that, when executed by the processor, configure the apparatus to receive, at a user equipment (UE), from a first network entity, an indication of a configuration for the UE to report, to the first network entity, whether the UE has estimated a first timing advance value for a second network entity, determine, at the UE, the estimate of the first timing advance value based at least in part on receiving the indication of the configuration, cause transmission, towards the first network entity, of an indication of whether the UE has estimated the first timing advance value for the second network entity, receive, from the first network entity, a second timing advance value, determine a third timing advance value based at least in part on the first timing advance value and the second timing advance value, and cause transmission, using the third timing advance value, towards the second network entity, of one or more communications.

In some cases, the instructions further configure the apparatus to determine an error value based at least in part on comparing the first timing advance value with the second timing advance value, where the UE determines the third timing advance value based at least in part on the error value. In some cases, the first timing advance value configuration further indicates that the UE is to report an identifier of the second network entity to the first network entity in an instance in which the UE has estimated the first timing advance value for the second network entity.

In some cases, the third timing advance value configuration further indicates that the UE is to perform one or more operations for determining the third timing advance value. In some cases, the configuration indicates that the UE is to report whether the UE has estimated a first timing advance value first timing advance value for the second network entity based at least in part on one or more conditions being satisfied. In some cases, the configuration indicates that the UE is to report whether the UE has estimated a first timing advance value first timing advance value for the second network entity based at least in part on one or more of (i) a change of a beam of the second network entity used for determining the estimate of the first timing advance value or (ii) a change of an SSB of the second network entity used for determining the estimate of the first timing advance value.

In some cases, the first timing advance value configuration indicates that the UE is to estimate the first timing advance value in an instance in which a fourth timing advance value for the first network entity is estimated by the UE. In some cases, the instructions further configure the apparatus to cause transmission, towards the first network entity, of information associated with the second network entity, the information includes one or more of: (i) reference signal information for the second network entity, (ii) an identifier for the second network entity, or (iii) a carrier frequency for communications with the second network entity. Other technical features may be readily apparent to one skilled in the art from the following figures, descriptions, and claims.

In one aspect, a computing apparatus includes a processor. The computing apparatus also includes a memory storing instructions that, when executed by the processor, configure the apparatus to cause transmission, by a first network entity and towards a user equipment (UE), of an indication of a configuration for the UE to report, to the first network entity, whether the UE has estimated a first timing advance value for a second network entity, receive, from the UE, an indication of whether the UE has estimated the first timing advance value for the second network entity, and cause transmission, towards the UE, of a second timing advance value, where causing the transmission is based at least in part on receiving the indication of whether the UE has estimated the first timing advance value.

In some cases, the first timing advance value configuration further indicates that the UE is to report an identifier of the second network entity to the first network entity in an instance in which the UE has estimated the first timing advance value for the second network entity. In some cases, the third timing advance value configuration further indicates that the UE is to perform one or more operations for determining the third timing advance value.

In some cases, the configuration indicates that the UE is to report whether the UE has estimated a first timing advance value first timing advance value for the second network entity based at least in part on one or more conditions being satisfied. In some cases, where the configuration indicates that the UE is to report whether the UE has estimated a first timing advance value first timing advance value for the second network entity based at least in part on one or more of (i) a change of a beam of the second network entity used for determining the estimate of the first timing advance value or (ii) a change of an SSB of the second network entity used for determining the estimate of the first timing advance value.

In some cases, where the instructions further configure the apparatus to receive, from the UE, information associated with the second network entity, the information includes one or more of: (i) reference signal information for the second network entity, (ii) an identifier for the second network entity, or (iii) a carrier frequency for communications with the second network entity. Other technical features may be readily apparent to one skilled in the art from the following figures, descriptions, and claims. In one aspect, a non-transitory computer-readable storage medium, the computer-readable storage medium including instructions that when executed by a computer, cause the computer to receive, at a user equipment (UE), from a first network entity, an indication of a configuration for the UE to report, to the first network entity, an estimate of a first timing advance value or an RSTD for a second network entity, determine, at the UE, the estimate of the first timing advance value based at least in part on receiving the indication of the configuration, cause transmission, towards the first network entity, of the estimate of the first timing advance value for the second network entity or a reference signal time difference associated with the estimate of the first timing advance value, receive, from the first network entity, an indication of an error value associated with the estimate of the first timing advance value for the second network entity, determine a second timing advance value based at least in part on the estimate of the first timing advance value and the error value, and cause transmission, using the second timing advance value, towards the second network entity, of one or more communications.

In some cases, the first timing advance value configuration indicates that the UE is to report the estimate of the first timing advance value for the second network entity based at least in part on an availability of the second network entity. In some cases, where the first timing advance value configuration indicates that the UE is to report the estimate of the first timing advance value for the second network entity based at least in part on one or more conditions being satisfied. In some cases, where the first timing advance value configuration indicates that the UE is to report the estimate of the first timing advance value for the second network entity based at least in part on one or more of (i) a change of a beam of the second network entity used for determining the estimate of the first timing advance value or (ii) a change of an SSB of the second network entity used for determining the estimate of the first timing advance value.

In some cases, the instructions further configure the computer to cause transmission, towards the first network entity, of information associated with the second network entity, the information includes one or more of: (i) reference signal information for the second network entity, (ii) an identifier for the second network entity, or (iii) a carrier frequency for communications with the second network entity. In some cases, receiving the indication of the error value further includes receiving a medium access control control element (MAC-CE) from the first network entity includes the indication of the error value. Other technical features may be readily apparent to one skilled in the art from the following figures, descriptions, and claims.

In one aspect, a non-transitory computer-readable storage medium, the computer-readable storage medium including instructions that when executed by a computer, cause the computer to cause transmission, by a first network entity and towards a user equipment (UE), of an indication of a configuration for the UE to report, to the first network entity, an estimate of a first timing advance value or an RSTD for a second network entity, receive, from the UE, the estimate of the first timing advance value for the second network entity, determine, by the first network entity, an error value associated with the estimate of the first timing advance value, where the determining is based at least in part receiving the estimate of the first timing advance value, and cause transmission, towards the UE, of an indication of the error value associated with the estimate of the first timing advance value for the second network entity.

In some cases, the instructions further configure the computer to receive, from the second network entity, a second timing advance value, where determining the error value based at least in part on a comparison of the first timing advance value and the second timing advance value. In some cases, the first timing advance value configuration indicates that the UE is to report the estimate of the first timing advance value for the second network entity based at least in part on an availability of the second network entity. In some cases, the first timing advance value configuration indicates that the UE is to report the estimate of the first timing advance value for the second network entity based at least in part on one or more conditions being satisfied.

In some cases, the first timing advance value configuration indicates that the UE is to report the estimate of the first timing advance value for the second network entity based at least in part on one or more of (i) a change of a beam of the second network entity used for determining the estimate of the first timing advance value or (ii) a change of an SSB of the second network entity used for determining the estimate of the first timing advance value. In some cases, the instructions further configure the computer to receive, from the UE, information associated with the second network entity, the information includes one or more of: (i) reference signal information for the second network entity, (ii) an identifier for the second network entity, or (iii) a carrier frequency for communications with the second network entity.

In some cases, causing transmission of the indication of the error value further includes causing transmission, towards the UE, of a medium access control control element (MAC-CE) includes the indication of the error value. Other technical features may be readily apparent to one skilled in the art from the following figures, descriptions, and claims. In one aspect, a non-transitory computer-readable storage medium, the computer-readable storage medium including instructions that when executed by a computer, cause the computer to receive, at a user equipment (UE), from a first network entity, an indication of a configuration for the UE to report, to the first network entity, whether the UE has estimated a first timing advance value for a second network entity, determine, at the UE, the estimate of the first timing advance value based at least in part on receiving the indication of the configuration, cause transmission, towards the first network entity, of an indication of whether the UE has estimated the first timing advance value for the second network entity, receive, from the first network entity, a second timing advance value, determine a third timing advance value based at least in part on the first timing advance value and the second timing advance value, and cause transmission, using the third timing advance value, towards the second network entity, of one or more communications.

In some cases, the instructions further configure the computer to determine an error value based at least in part on comparing the first timing advance value with the second timing advance value, where the UE determines the third timing advance value based at least in part on the error value. In some cases, the first timing advance value configuration further indicates that the UE is to report an identifier of the second network entity to the first network entity in an instance in which the UE has estimated the first timing advance value for the second network entity.

In some cases, the third timing advance value configuration further indicates that the UE is to perform one or more operations for determining the third timing advance value. In some cases, the configuration indicates that the UE is to report whether the UE has estimated a first timing advance value first timing advance value for the second network entity based at least in part on one or more conditions being satisfied. In some cases, the configuration indicates that the UE is to report whether the UE has estimated a first timing advance value first timing advance value for the second network entity based at least in part on one or more of (i) a change of a beam of the second network entity used for determining the estimate of the first timing advance value or (ii) a change of an SSB of the second network entity used for determining the estimate of the first timing advance value.

In some cases, the first timing advance value configuration indicates that the UE is to estimate the first timing advance value in an instance in which a fourth timing advance value for the first network entity is estimated by the UE. In some cases, the instructions further configure the computer to cause transmission, towards the first network entity, of information associated with the second network entity, the information includes one or more of: (i) reference signal information for the second network entity, (ii) an identifier for the second network entity, or (iii) a carrier frequency for communications with the second network entity. Other technical features may be readily apparent to one skilled in the art from the following figures, descriptions, and claims.

In one aspect, a non-transitory computer-readable storage medium, the computer-readable storage medium including instructions that when executed by a computer, cause the computer to cause transmission, by a first network entity and towards a user equipment (UE), of an indication of a configuration for the UE to report, to the first network entity, whether the UE has estimated a first timing advance value for a second network entity, receive, from the UE, an indication of whether the UE has estimated the first timing advance value for the second network entity, and cause transmission, towards the UE, of a second timing advance value, where causing the transmission is based at least in part on receiving the indication of whether the UE has estimated the first timing advance value.

In some cases, the first timing advance value configuration further indicates that the UE is to report an identifier of the second network entity to the first network entity in an instance in which the UE has estimated the first timing advance value for the second network entity. In some cases, the third timing advance value configuration further indicates that the UE is to perform one or more operations for determining the third timing advance value.

In some cases, the configuration indicates that the UE is to report whether the UE has estimated a first timing advance value first timing advance value for the second network entity based at least in part on one or more conditions being satisfied. In some cases, the configuration indicates that the UE is to report whether the UE has estimated a first timing advance value first timing advance value for the second network entity based at least in part on one or more of (i) a change of a beam of the second network entity used for determining the estimate of the first timing advance value or (ii) a change of an SSB of the second network entity used for determining the estimate of the first timing advance value.

In some cases, the instructions further configure the computer to receive, from the UE, information associated with the second network entity, the information includes one or more of: (i) reference signal information for the second network entity, (ii) an identifier for the second network entity, or (iii) a carrier frequency for communications with the second network entity. Other technical features may be readily apparent to one skilled in the art from the following figures, descriptions, and claims. In some cases, the one or more conditions comprise one or more of: (i) a signal strength measurement for a signal received from the second network entity being greater than a signal strength measurement for a signal received from the first network entity, (ii) the signal strength measurement for the signal received from the second network entity satisfying a threshold, or (iii) one or more criteria associated with beam quality for the second network entity being satisfied.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 illustrates a signal flow diagram via which a user equipment (UE) and a base station may perform Layer 1/Layer 2 triggered mobility (LTM) operations;

FIG. 2 illustrates a signal flow diagram that provides examples of additional signaling performed for LTM operations;

FIG. 3 is an example of a timing diagram that illustrates various delays between signals received from different transmit/receive points (TRPs);

FIG. 4 illustrates a wireless communications system that supports techniques determining timing advances (TAs) in accordance with examples described herein;

FIG. 5 illustrates an apparatus that supports improved techniques for determining TAs in accordance with examples described herein;

FIG. 6 illustrates a signal flow diagram for TA determination using network-based error estimation;

FIG. 7 illustrates a signal flow diagram for TA determination using user equipment (UE) based error estimation; and

FIGS. 8-11 are flowcharts of operations according to certain example embodiments implemented, for example, by an apparatus as described herein.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with certain embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device (such as a core network apparatus), field programmable gate array, and/or other computing device.

As used herein, the term “computer-readable medium” refers to non-transitory storage hardware, non-transitory storage device or non-transitory computer system memory that may be accessed by a controller, a microcontroller, a computational system or a module of a computational system to encode thereon computer-executable instructions or software programs. A non-transitory “computer-readable medium” may be accessed by a computational system or a module of a computational system to retrieve and/or execute the computer-executable instructions or software programs encoded on the medium. Examples of non-transitory computer-readable media may include, but are not limited to, one or more types of hardware memory, non-transitory tangible media (for example, one or more magnetic storage disks, one or more optical disks, one or more USB flash drives), computer system memory or random-access memory (such as, DRAM, SRAM, EDO RAM), and the like.

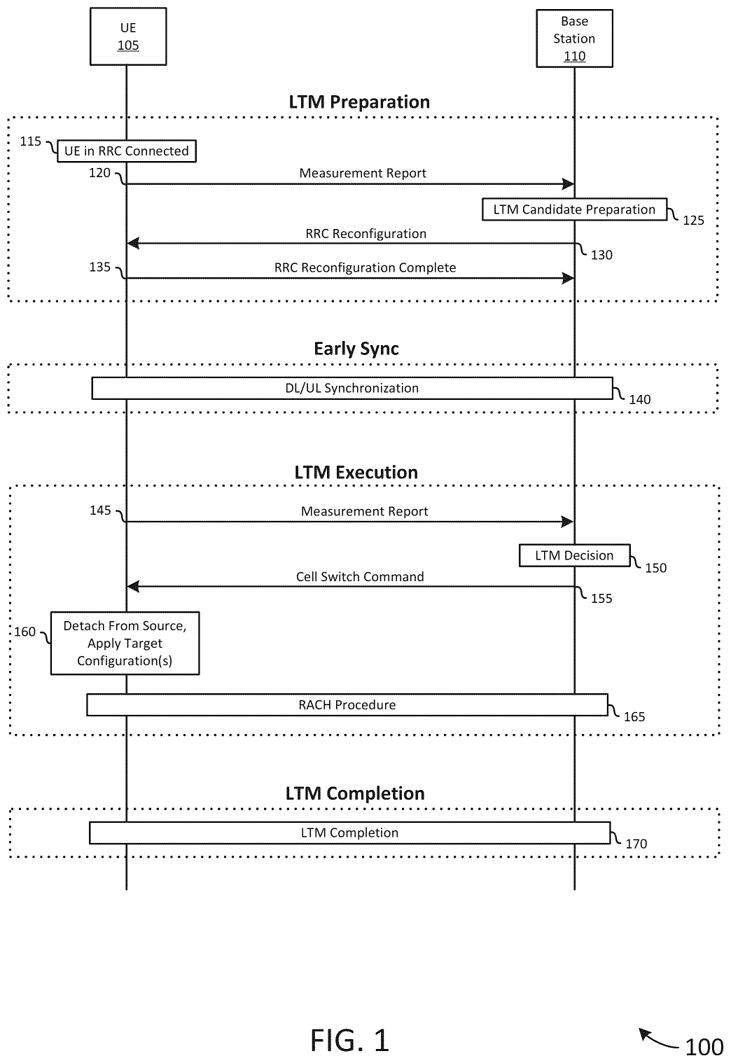

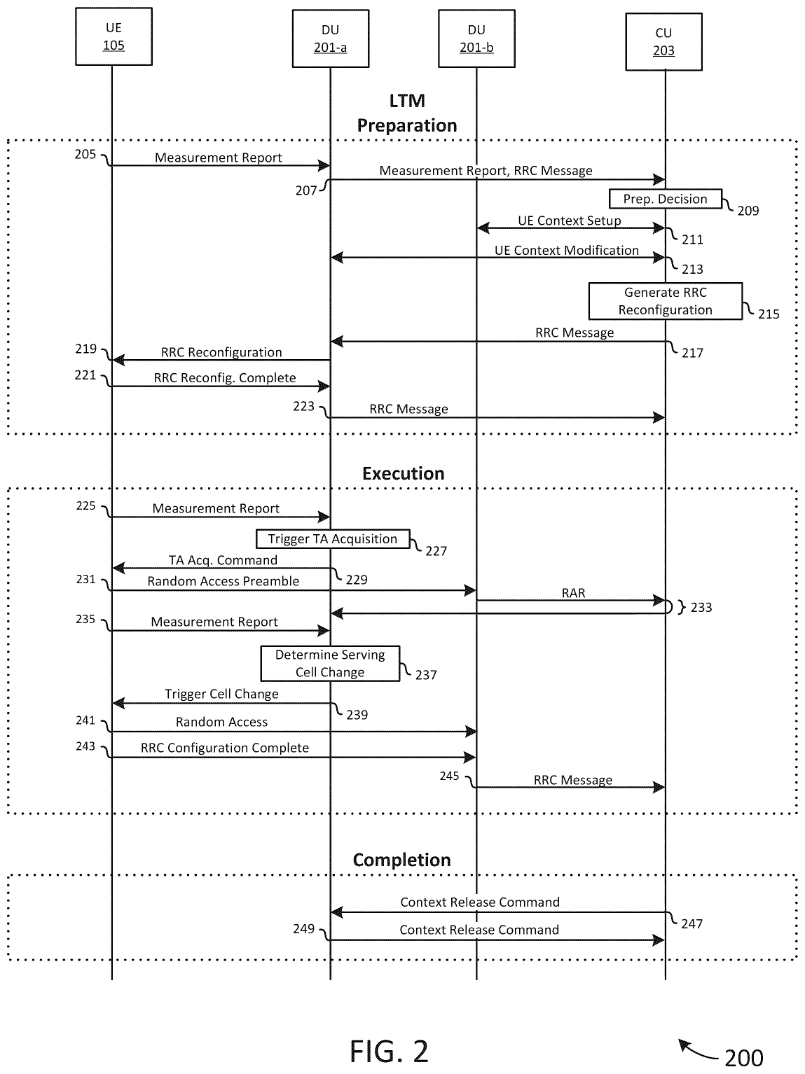

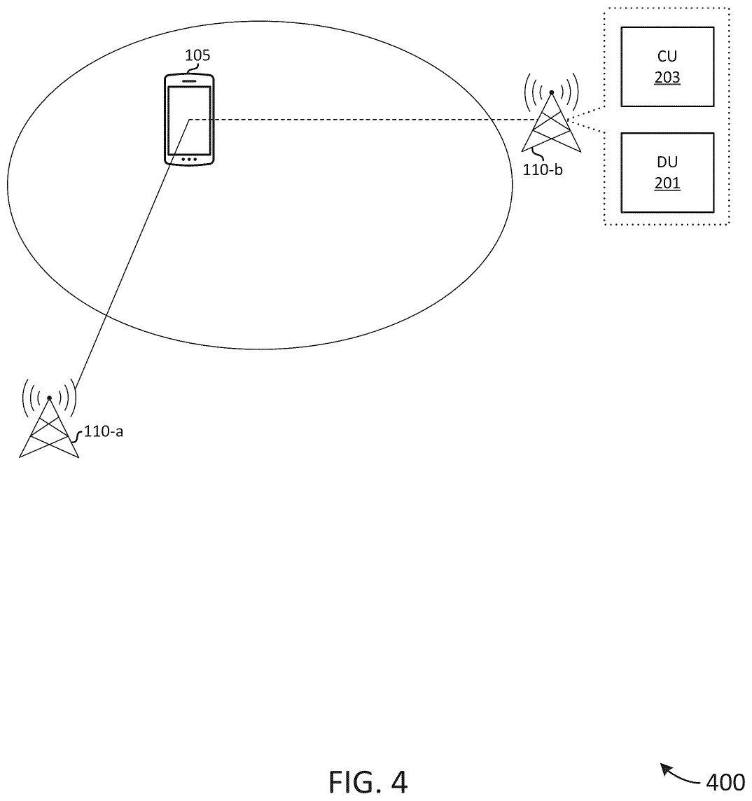

FIG. 4 illustrates an example of a wireless communications system 400 that supports methods and apparatuses for improved determination of timing advances. In some embodiments, the wireless communications system 400 may include one or more UEs 105 and one or more base stations 110 of a radio access network (RAN), which may be in communication with each other. The one or more base stations 110 may be examples of network entities and may be embodied by any of a variety of access points or nodes including, for example, a Node B (e.g., a gNB), or the like of a RAN. In some cases, the UEs 105 and/or the RAN, such as the base stations 110 of the RAN, may be in communication with a core network including one or more network nodes of the core network. As shown in FIG. 1, base stations 110 of an example embodiment may include one or more CUs 203 and one or more DUs 201, which may be examples of corresponding CUs 203 and DUs 201 as described with reference to FIG. 2.

By way of example, the wireless communications system 400 may be deployed within a radio access architecture based on long term evolution advanced (LTE Advanced, LTE-A) and/or new radio (NR, 5G). However, the system may be deployed in other network architectures including within other communication networks including, for example, other communication networks developed in the future, e.g., sixth generation (6G) networks, as well as any of a number of existing networks including a universal mobile telecommunication system (UMTS), radio access network (UTRAN or E-UTRAN), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

The UE 105 may be any type of user terminal, terminal device, node (e.g., network node), element (e.g., network element), etc. to which resources on the air interface are allocated and assigned. For example, the UE 105 may be a portable computing device such as a wireless mobile communication device including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, multimedia device, car, truck, drone, airplane and other types of vehicles. As a non-exhaustive list of some examples, the UE 105 may also be called a subscriber unit, mobile station, network element, remote terminal, access terminal, or user terminal.

In accordance with one or more aspects of the present disclosure, the UE 105 and the base stations 110 may perform various techniques for determining (e.g., estimating) timing advances (TAs) that effectively estimate timing errors without introducing signaling overhead or TA validity challenges. In one embodiment, error estimation may be performed by the network. A UE 105 may estimate a TA (e.g., TA1) of a target cell (e.g., a target DU 201). The UE 105 may then inform a serving cell (e.g., a source cell, a source DU 201) of the estimated TA. The serving cell (e.g., the serving DU 201) triggers the RACH-based TA acquisition for the same target cell (the target cell that the UE 105 has estimated the TA for, TA1) and acquires the TA (e.g., TA2). The serving DU then evaluates the estimation error (including timing alignment error and other potential impairments) of TA1 using both TA1 and TA2. The serving DU provides the estimation error to UE 105 and the UE 105 uses the estimation error to correct its TA estimation.

In another embodiment, error estimation may be performed by the UE 105. The UE 105 may estimate the TA of a target cell (e.g., TA1). The UE 105 then notifies the serving cell about the target cell that the UE 105 estimated the TA for. The serving cell triggers the RACH-based TA acquisition for the same target cell (e.g., the target cell that the UE 105 has estimated the TA for, TA1) and acquires the TA (e.g., TA2). The serving cell forwards the evaluated TA (e.g., TA2) to the UE 105 and the UE 105 evaluates the estimation error using both TA1 and TA2. The UE 105 uses this estimation error value to correct its TA estimation.

In some cases, the UE 105 may also be first triggered with the RACH based TA acquisition and receive the TA directly afterward. The UE 105 may then be configured to continue the UE-based TA estimate considering the RACH-based TA that is acquired by the UE 105. Hence, in both solutions, the UE 105 may not require re-acquisition of the TA as the TA invalidity issue may not occur. Additionally, the UE estimate may be corrected with that approach and UE 105 may use the corrected TA estimate for RACH-less handover.

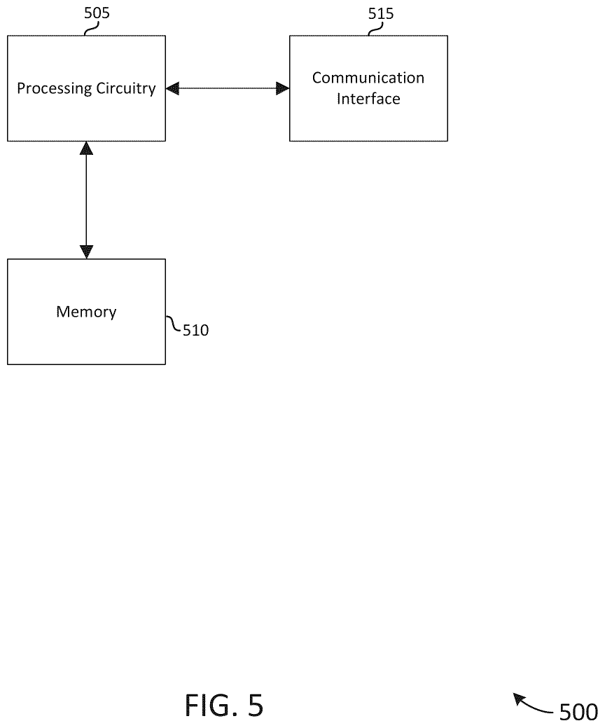

FIG. 5 illustrates an example of an apparatus 500 that supports methods for improved determination of TAs. The apparatus 500 may be embodied by or may comprise a network element, such as a UE 105 or a base station 110, configured to perform one or more for determining TAs. As shown in FIG. 5, the apparatus 500 may include, be associated with, or be in communication with processing circuitry 505 (e.g., one or more processors), a memory 510 and a communication interface 515. The processing circuitry may be in communication with the memory 510 via a bus for passing information among components of the apparatus. The memory 510 may be non-transitory and may include, for example, one or more volatile and/or non-volatile memories. In other words, for example, the memory 510 may be an electronic storage device (e.g., a computer readable storage medium) comprising storage components configured to store data (e.g., bits) that may be retrievable by a machine (e.g., a computing device like the processing circuitry 505). The memory 510 may be configured to store information, data, content, applications, instructions, or the like for enabling the apparatus 500 to carry out various functions in accordance with an example embodiment of the present disclosure. For example, the memory 510 may be configured to buffer input data for processing by the processing circuitry 505. Additionally, or alternatively the memory 510 may be configured to store instructions for execution by the processing circuitry 505.

The apparatus 500 may, in some embodiments, be embodied in various computing devices as described above. However, in some embodiments, the apparatus 500 may be embodied as a chip or chip set. In other words, the apparatus 500 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 500 may therefore, in some cases, be configured to implement an embodiment of the present invention on a single chip or as a single “system on a chip.” As such, in some cases, a chip or chipset may constitute means for performing one or more operations for providing the functionalities described herein.

The processing circuitry 505 may be embodied in a number of different ways. For example, the processing circuitry 505 may be embodied as one or more of various hardware processing means such as a coprocessor, a microprocessor, a controller, a digital signal processor (DSP), a processing element with or without an accompanying DSP, or various other circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry 505 may include one or more processing cores configured to perform independently. A multi-core processing circuitry may enable multiprocessing within a single physical package. Additionally, or alternatively the processing circuitry 505 may include one or more processors configured in tandem via the bus to enable independent execution of instructions, pipelining and/or multithreading.

In an example embodiment, the processing circuitry 505 may be configured to execute instructions stored in the memory 510 or otherwise accessible to the processing circuitry 505. Additionally, or alternatively, the processing circuitry 505 may be configured to execute hard coded instructions. As such, whether configured by hardware or software methods, or by a combination thereof, the processing circuitry 505 may represent an entity (e.g., physically embodied in circuitry) capable of performing operations according to an embodiment of the present disclosure while configured accordingly. Thus, for example, when the processing circuitry 505 is embodied as an ASIC, FPGA or the like, the processing circuitry 505 may be specifically configured hardware for conducting the operations described herein. Alternatively, as another example, when the processing circuitry 505 is embodied as an executor of instructions, the instructions may specifically configure the processing circuitry 505 to perform the algorithms and/or operations described herein when the instructions are executed. However, in some cases, the processing circuitry 505 may be a processor of a specific device (e.g., an image or video processing system) configured to employ an embodiment of the present invention by further configuration of the processing circuitry 505 by instructions for performing the algorithms and/or operations described herein. The processing circuitry 505 may include, among other things, a clock, an arithmetic logic unit (ALU) and logic gates configured to support operation of the processing circuitry 505.

The communication interface 515 may be any means such as a device or circuitry embodied in either hardware or a combination of hardware and software that is configured to receive and/or transmit data, including media content in the form of video or image files, one or more audio tracks or the like. In this regard, the communication interface 515 may include, for example, an antenna (or multiple antennas) and supporting hardware and/or software for enabling communications with a wireless communication network (e.g., with one or more communication devices of the wireless communications system 100). Additionally, or alternatively the communication interface 515 may include one or more antennas to cause transmission of signals via the one or more antennas or to handle receipt of signals received via the one or more antennas. In some environments, the communication interface 515 may alternatively or also support wired communication. As such, for example, the communication interface 515 may include a communication modem and/or other hardware/software for supporting communication via cable, digital subscriber line (DSL), universal serial bus (USB) or other mechanisms.

In some cases, the apparatus 500 may be configured to perform one or more tasks relevant to a use case application of artificial intelligence (e.g., using artificial intelligence for UE positioning). For example, the apparatus 500 may be configured to utilize one or more machine learning models for one or more CSI processes, such as a CSI determination process. In such cases, the apparatus 500 may utilize the machine learning model to predict CSI for one or more channels, which may enhance one or more operations performed by the apparatus 500. In addition to machine-learning-assisted CSI processes, the apparatus 500 may utilize one or more artificial intelligence models for beam management, for positioning, or for any other type of operations performed by the apparatus 500. However, utilizing artificial models for various operations at the apparatus 500 may consume more resources than performing the same tasks without reliance upon artificial intelligence.

In accordance with one or more aspects of the present disclosure, the apparatus 500 may be configured (e.g., proactively), with a mapping table that links (e.g., associates, pairs) respective implementations (e.g., configurations, operations, features, functionalities, models, model parameters) for performing one or more tasks with corresponding required allocations of resources of the apparatus 500, where the resources refer either to the physical resources at the apparatus or the resources provided by another network entity for the apparatus to perform the respective task. The apparatus 500 may then select an implementation corresponding to a current condition of the apparatus 500, which may improve resource utilization and performance of the apparatus 500.

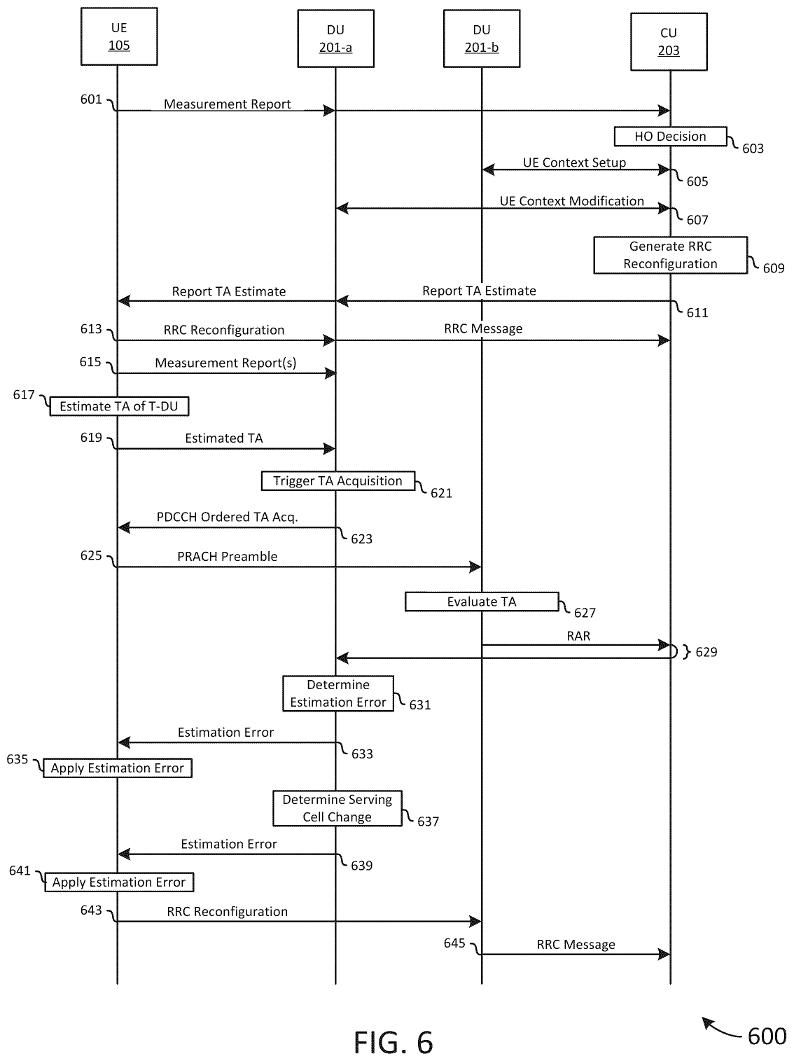

FIG. 6 illustrates an example of a signal flow diagram 600 that supports techniques for improved determination of TAs. For example, the signal flow diagram 600 may support techniques for network-based error determination associated with TAs. The signal flow diagram 600 may include a UE 105, a DU 201-a, a DU 201-b, and a CU 203, which may perform the operations described herein. The flow diagram 600 may provide one illustrative example of an order or sequencing for the operations described herein, however, any order or sequencing may be used. In some cases, one or more operations of the signal flow diagram 600 may not be performed or may otherwise be omitted. Additionally, or alternatively, the UE 105, the DU 201-a, the DU 201-b, and the CU 203 may perform operations that are not shown in the signal flow diagram 600.

In some cases, the signal flow diagram 600 may illustrate an intra-CU scenario (e.g., with one CU 203 and multiple DUs 201 under the CU 203). However, the source DU (e.g., the DU 201-a) and the target DU (e.g., the DU 201-b) may be connected to different CUs 203. For example, the operations of the signal flow diagram 600 may also be applied to an inter-CU inter-DU mobility scenario. Although not shown in the signal flow diagram 600, an initial operation may include the UE 105 establishing a connection with the DU 201-a. Additionally, it should be noted that the UE 105 may have the capability of both RACH-based early TA acquisition and UE-based TA estimation. Such UE capability information may be known at the network (e.g., as part of UE capability information).

At 601, the UE 105 may transmit a measurement report (e.g., an L3 measurement report) to the DU 201-a (e.g., a source DU, a source cell). Additionally, the DU 201-a may transmit the measurement report to the CU 203. At 603, the CU 203 may make a handover determination. For example, the CU 203 may select one or more target cells (e.g., the DU 201-b) for handover. At 605, the CU 203 may transmit a UE context setup request to the DU 201-b. Additionally, or alternatively, the CU 203 may receive a UE context setup response from the DU 201-b.

At 607, the CU 203 may transmit a UE context modification request to the DU 201-a. Additionally, or alternatively, the CU 203 may receive a UE context modification response from the DU 201-a. At 609, the CU 203 may generate one or more RRC configurations (e.g., one or more RRC reconfigurations). The one or more RRC configurations may include a measurement configuration of an L1 cell change and a configuration of prepared cells. At 611, the CU 203 may configure the UE 105 to report the UE-based TA estimate. For example, the CU 203 may transmit a configuration to the UE 105 via the DU 201-a that indicates that the UE is to report the UE-based TA estimate. In one embodiment, the configuration leads the UE 105 to report the TA estimate of a cell as soon as it is available. In another embodiment, the UE 105 reports the TA estimate if the cell with estimated TA meets certain radio conditions (e.g., if its radio measurements are X dB stronger than radio measurements for a serving cell or stronger than a threshold Y, or for the N-best measured target-cell beams). In one example, the UE 105 may be configured to estimate and report the TA of a candidate cell again when the radio conditions of the candidate cell change (e.g., best beam synchronization signal block (SSB) or the SSB used to estimate the TA measurement is different compared to the one used for the previously reported TA value).

At 613, the UE 105 may transmit, via the DU 201-a, an indication that the RRC configuration (e.g., the RRC reconfiguration) is complete. At 615, the UE 105 reports one or more L1 measurements to the DU 201-a. At 617, The UE 105 performs the TA estimate of the DU 201-b. This procedure may be triggered by the DU 201-a (e.g., based on the measurement report). For example, the DU 201-a may transmit a MAC-CE to the UE 105 that triggers the UE 105 to perform the TA estimate. At 619, based on the configuration received at 611, the UE 105 may report the estimated TA to the DU 201-a. In one embodiment, the UE 105 may also include reference signal information (e.g., an SSB index) of the DU 201-b used for TA estimation along with the cell ID and frequency.

At 621, the DU 201-a may trigger or determine to trigger a TA acquisition for a target cell (e.g., for the DU 201-b). In one embodiment, the UE 105 may autonomously initiate the RACH-based TA acquisition (e.g., the configuration of 611 may mandates the UE 105 for RACH-based TA acquisition after reporting the estimated TA). The UE 105 may select the same SSB to perform UE-based and RACH-based TA acquisition. The contention free random access (CFRA) resources to perform RACH may be provided to the UE 105 at 611. In some cases, if estimated TA is above a certain threshold or the difference between the TA of the target cell and that of the serving cell exceeds a certain threshold, TA acquisition may be triggered for the target cell. In such cases, the operations performed at 623 may not be performed (e.g., because the configuration may be given to the UE 105 prior to 613).

At 623, if the UE 105 is not configured with autonomous TA acquisition followed by the reporting of the estimated TA, the UE 105 may receive the PDCCH ordered TA acquisition command to send the PRACH preamble towards the DU 201-b so that the DU 201-b may estimate the TA. At 625, the UE 105 may transmit a random-access preamble to the DU 201-b. The UE 105 may transmit the random-access preamble so that the DU 201-b (e.g., the target DU 201) may estimate a TA for the DU 201-b. The UE 105 may send the PRACH preamble to DU 201-b either as instructed by the DU 201-a or as configured (e.g., at 611) along with TA estimate report (e.g., TA estimate report triggers the PRACH preamble transmission). At 627, the DU 201-b evaluates the TA between the UE 105 and the DU 201-b and sends this evaluation to the DU 201-a via CU 203.

At 629, the DU 201-b transmits a random-access response (RAR) to the DU 201-a via the CU 203. The RAR may include an indication of the TA. At 631, the DU 201-a uses the TA reported by the UE 105 (e.g., at 619) and the TA received from the DU 201-b (e.g., at 629) to evaluate the estimation error of the TA that is reported at 619. At 633, the DU 201-a may send the estimation error to UE 105 immediately after it is evaluated. At 635, the UE 105 may correct its TA estimate based on the estimation error. At 637, the DU 201-a determine to trigger a serving cell change for the UE 105. For example, the DU 201-a may determine that the DU 201-b is the new serving cell for the UE 105.

At 639, the DU 201-a may transmit a MAC-CE command to the UE 105 to trigger the serving cell change. In some cases, the estimation error may be communicated to the UE 105 via the MAC-CE command. At 641, the UE 105 may correct its TA estimate based on the estimation error. At 643, the UE 105 may transmit an indication to the DU 201-b that the RRC configuration is complete. At 645, the DU 201-b may transmit the indication that the RRC configuration is complete to the CU. In some cases, the UE 105 may also be triggered with the RACH based TA acquisition and receive the TA directly afterwards. In such cases, the UE 105 may then be configured to continue the UE-based TA estimate considering the RACH based TA that is acquired by the UE 105. The techniques described herein may be applied to for conditional handover (CHO) to improve the CHO performance (e.g., RACH-less CHO). For CHO, the UE 105 may autonomously execute the handover configuration once the condition configured to the UE 105 is met. Hence, the UE 105 may not need any MAC-CE command for triggering the cell change.

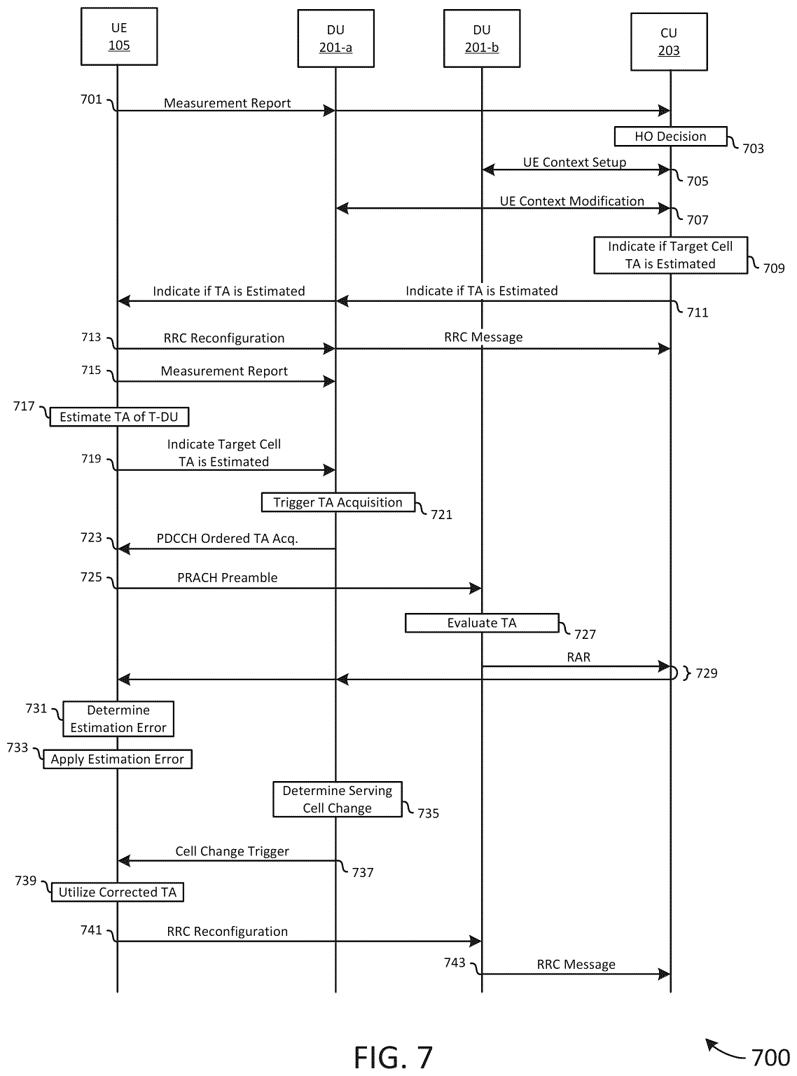

FIG. 7 illustrates an example of a signal flow diagram 700 that supports techniques for improved determination of TAs. For example, the signal flow diagram 700 may support techniques for network-based error determination associated with TAs. The signal flow diagram 700 may include a UE 105, a DU 201-a, a DU 201-b, and a CU 203, which may perform the operations described herein. The flow diagram 700 may provide one illustrative example of an order or sequencing for the operations described herein, however, any order or sequencing may be used. In some cases, one or more operations of the signal flow diagram 700 may not be performed or may otherwise be omitted. Additionally, or alternatively, the UE 105, the DU 201-a, the DU 201-b, and the CU 203 may perform operations that are not shown in the signal flow diagram 700.

In some cases, the signal flow diagram 700 may illustrate an intra-CU scenario (e.g., with one CU 203 and multiple DUs 201 under the CU 203). However, the source DU (e.g., the DU 201-a) and the target DU (e.g., the DU 201-b) may be connected to different CUs 203. For example, the operations of the signal flow diagram 700 may also be applied to an inter-CU inter-DU mobility scenario. Although not shown in the signal flow diagram 700, an initial operation may include the UE 105 establishing a connection with the DU 201-a. Additionally, it should be noted that the UE 105 may have the capability of both RACH-based early TA acquisition and UE-based TA estimation. Such UE capability information may be known at the network (e.g., as part of UE capability information).

At 701, the UE 105 may transmit a measurement report (e.g., an L3 measurement report) to the DU 201-a (e.g., a source DU, a source cell). Additionally, the DU 201-a may transmit the measurement report to the CU 203. At 703, the CU 203 may make a handover determination. For example, the CU 203 may select one or more target cells (e.g., the DU 201-b) for handover. At 705, the CU 203 may transmit a UE context setup request to the DU 201-b. Additionally, or alternatively, the CU 203 may receive a UE context setup response from the DU 201-b. At 707, the CU 203 may transmit a UE context modification request to the DU 201-a. Additionally, or alternatively, the CU 203 may receive a UE context modification response from the DU 201-a.

At 709, the CU 203 may proceed with the UE context setup/modification procedures and may generate RRC reconfiguration(s) for the prepared cell(s) for LTM. The CU 203 may also configures the UE 105 to indicate the target cell (e.g., the DU 201-b) if it achieves the UE-based estimate of the TA. In another embodiment, the UE 105 may report the TA estimate if the cell with estimated TA meets certain radio conditions (e.g., if its radio measurements are X dB stronger than the serving cell or stronger than a threshold Y, or for the n-best measured target-cell beams). In one example, the UE 105 may be configured to estimate and report the TA of a candidate cell again when the radio conditions of the candidate cell change, e.g., best beam (e.g., SSB) or the SSB used to estimate the TA measurement is different compared to the one used for the previously reported TA value. In another embodiment, the configuration causes the UE 105 to trigger the RACH-based TA acquisition towards a target cell after the UE-based TA estimate of the same cell is achieved. Accordingly, the UE 105 may receive the indication and configuration for the UE autonomous RACH-based TA acquisition procedure.

At 711, the CU 203 may transmit an indication of the configuration to the UE 105 via the DU 201-a. At 713, the UE 105 may transmit, via the DU 201-a, an indication that the RRC configuration (e.g., the RRC reconfiguration) is complete. At 715, the UE 105 reports one or more L1 measurements to the DU 201-a. At 717, The UE 105 performs the TA estimate of the DU 201-b. This procedure may be triggered by the DU 201-a (e.g., based on the measurement report). For example, the DU 201-a may transmit a MAC-CE to the UE 105 that triggers the UE 105 to perform the TA estimate.

At 719, based on the configuration received at 711, the UE 105 may indicate that it has estimated the TA of the DU 201-b. In one embodiment, the UE 105 may also include the RS information (e.g., an SSB index) of the target cell used for TA estimation along with the cell ID and frequency (e.g., carrier frequency). At 721, the DU 201-a may trigger or determine to trigger a TA acquisition for a target cell (e.g., for the DU 201-b). In one embodiment, the UE 105 may autonomously initiate the RACH-based TA acquisition (e.g., the configuration of 611 may mandates the UE 105 for RACH-based TA acquisition after reporting the estimated TA). The UE 105 may select the same SSB to perform UE-based and RACH-based TA acquisition. The contention free random access (CFRA) resources to perform RACH may be provided to the UE 105 at 611. In some cases, if estimated TA is above a certain threshold or the difference between the TA of the target cell and that of the serving cell exceeds a certain threshold, TA acquisition may be triggered for the target cell. In such cases, the operations performed at 623 may not be performed (e.g., because the configuration may be given to the UE 105 prior to 613).

At 723, if the UE 105 is not configured with autonomous TA acquisition followed by the reporting of the estimated TA, the UE 105 may receive the PDCCH ordered TA acquisition command to send the PRACH preamble towards the DU 201-b so that the DU 201-b may estimate the TA. At 725, the UE 105 may transmit a random-access preamble to the DU 201-b. The UE 105 may transmit the random-access preamble so that the DU 201-b (e.g., the target DU 201) may estimate a TA for the DU 201-b. The UE 105 may send the PRACH preamble to DU 201-b either as instructed by the DU 201-a or as configured (e.g., at 611) along with TA estimate report (e.g., TA estimate report triggers the PRACH preamble transmission). At 727, the DU 201-b evaluates the TA between the UE 105 and the DU 201-b and sends this evaluation to the DU 201-a via CU 203. At 729, the CU 203 may transmit a RAR to the UE 105 via the DU 201-a. The RAR may include the evaluation of the TA.

At 731, the UE 105 may determine the estimation error based on the evaluation of the TA. At 733, the UE 105 may apply the estimation error to correct its previously estimated TA. At 735, the DU 201-a determine to trigger a serving cell change for the UE 105. For example, the DU 201-a may determine that the DU 201-b is the new serving cell for the UE 105. At 737, the DU 201-a may transmit an indication of the cell change trigger to the UE 105-a. The indication of the cell change trigger may be included in a MAC-CE. The MAC-CE may additionally include an indication of the TA for the target cell. At 739, the UE 105 may utilized the corrected TA.

At 741, the UE 105 may transmit an indication to the DU 201-b that the RRC configuration is complete. At 745, the DU 201-b may transmit the indication that the RRC configuration is complete to the CU. In some cases, the UE 105 may also be triggered with the RACH based TA acquisition and receive the TA directly afterwards. In such cases, the UE 105 may then be configured to continue the UE-based TA estimate considering the RACH based TA that is acquired by the UE 105. The techniques described herein may be applied to for conditional handover (CHO) to improve the CHO performance (e.g., RACH-less CHO). For CHO, the UE 105 may autonomously execute the handover configuration once the condition configured to the UE 105 is met. Hence, the UE 105 may not need any MAC-CE command for triggering the cell change.

The techniques described herein may prevents the UE 105 from reacquiring the TA multiple times if it becomes invalid. The proposed method also improves the accuracy of the UE-based TA estimate. This may prevent unwanted RACH-less failure that may lead delayed access (e.g., if RACH fallback is configured). If RACH fallback is not configured, the proposed solution may prevents handover failure due to erroneous UE-based TA estimates. Additionally, the techniques described herein may increase a size of the application area of the UE-based TA estimate of the synchronous cells with relatively long CPs to synchronous cells with relatively short CPs as well as asynchronous cells.

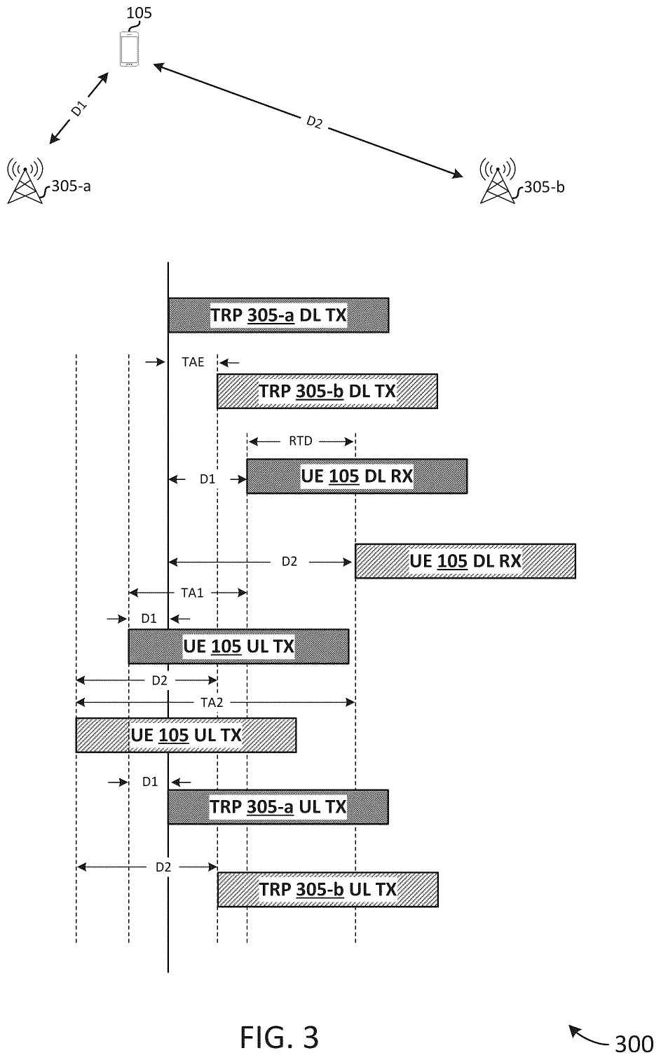

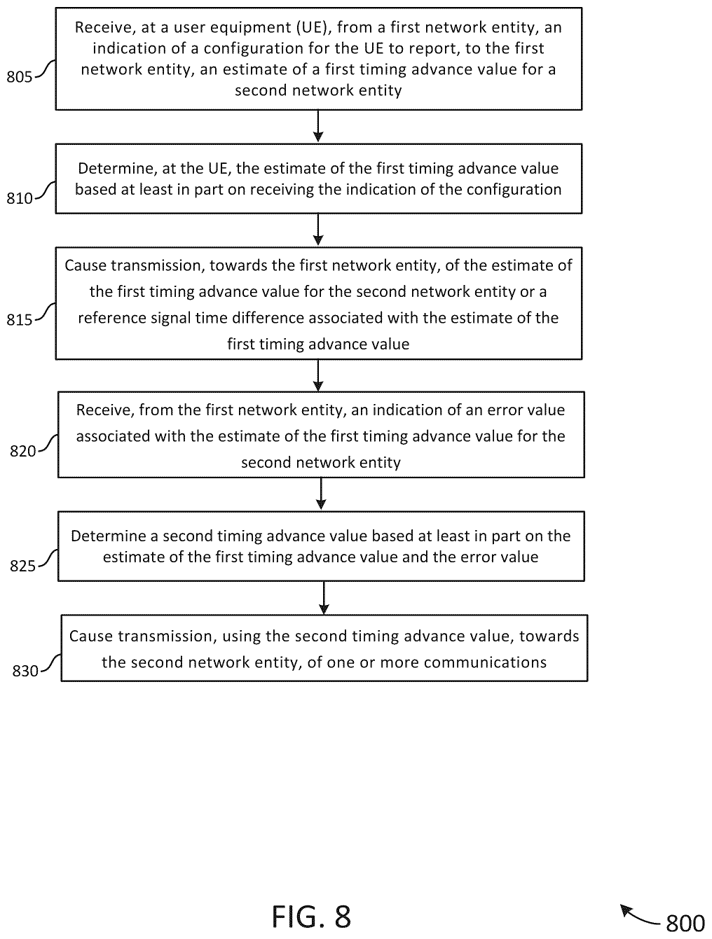

FIG. 8 illustrates an example of a flowchart 800 of the operations performed by an apparatus, such as may be embodied by a UE 105, a base station 110 or the like, as described with reference to FIGS. 1-7.

As shown in block 805, the apparatus may include means, such as the processing circuitry 505, the communication interface 515 or the like, for receiving, at a UE, from a first network entity, an indication of a configuration for the UE to report, to the first network entity, an estimate of a first timing advance value for a second network entity.

As shown in block 810, the apparatus may include means, such as the processing circuitry 505 or the like, for determining, at the UE, the estimate of the first timing advance value based at least in part on receiving the indication of the configuration.

As shown in block 815, the apparatus may include means, such as the processing circuitry 505, the communication interface 515 or the like, for causing transmission, towards the first network entity, of the estimate of the first timing advance value for the second network entity or a reference signal time difference associated with the estimate of the first timing advance value.

As shown in block 820, the apparatus may include means, such as the processing circuitry 505, the communication interface 515 or the like, for receiving, from the first network entity, an indication of an error value associated with the estimate of the first timing advance value for the second network entity.

As shown in block 825, the apparatus may include means, such as the processing circuitry 505 or the like, for determining a second timing advance value based at least in part on the estimate of the first timing advance value and the error value.

As shown in block 830, the apparatus may include means, such as the processing circuitry 505, the communication interface 515 or the like, for causing transmission, using the second timing advance value, towards the second network entity, of one or more communications.

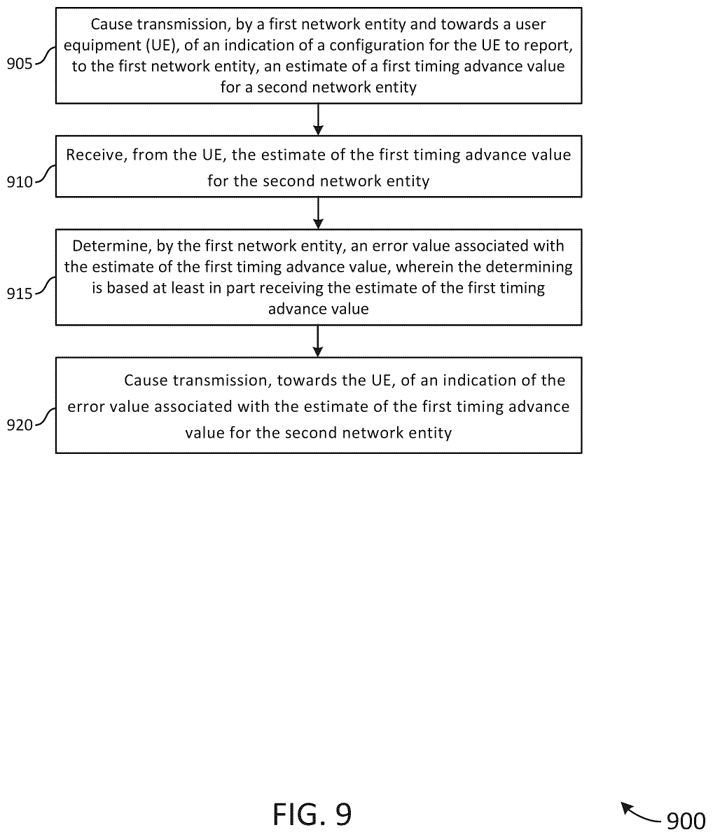

FIG. 9 illustrates an example of a flowchart 900 of the operations performed by an apparatus, such as may be embodied by a UE 105, a base station 110 or the like, as described with reference to FIGS. 1-7.

As shown in block 905, the apparatus may include means, such as the processing circuitry 505, the communication interface 515 or the like, for causing transmission, by a first network entity and towards a user equipment (UE), of an indication of a configuration for the UE to report, to the first network entity, an estimate of a first timing advance value for a second network entity.

As shown in block 910, the apparatus may include means, such as the processing circuitry 505, the communication interface 515 or the like, for receiving, from the UE, the estimate of the first timing advance value for the second network entity.

As shown in block 915, the apparatus may include means, such as the processing circuitry 505 or the like, for determining, by the first network entity, an error value associated with the estimate of the first timing advance value, wherein the determining is based at least in part receiving the estimate of the first timing advance value.

As shown in block 920, the apparatus may include means, such as the processing circuitry 505, the communication interface 515 or the like, for causing transmission, towards the UE, of an indication of the error value associated with the estimate of the first timing advance value for the second network entity.

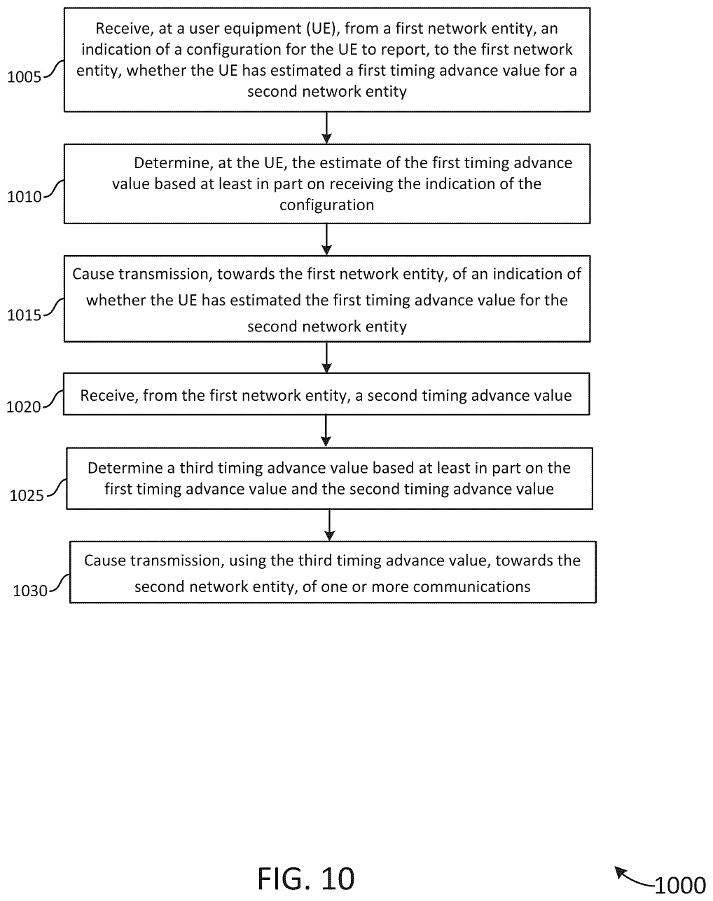

FIG. 10 illustrates an example of a flowchart 1000 of the operations performed by an apparatus, such as may be embodied by a UE 105, a base station 110 or the like, as described with reference to FIGS. 1-7.

As shown in block 1005, the apparatus may include means, such as the processing circuitry 505, the communication interface 515 or the like, for receiving, at a UE, from a first network entity, an indication of a configuration for the UE to report, to the first network entity, whether the UE has estimated a first timing advance value for a second network entity

As shown in block 1010, the apparatus may include means, such as the processing circuitry 505 or the like, for determining, at the UE, the estimate of the first timing advance value based at least in part on receiving the indication of the configuration.

As shown in block 1015, the apparatus may include means, such as the processing circuitry 505, the communication interface 515 or the like, for causing transmission, towards the first network entity, of an indication of whether the UE has estimated the first timing advance value for the second network entity.

As shown in block 1020, the apparatus may include means, such as the processing circuitry 505, the communication interface 515 or the like, for receiving, from the first network entity, a second timing advance value.

As shown in block 1025, the apparatus may include means, such as the processing circuitry 505 or the like, for determining a third timing advance value based at least in part on the first timing advance value and the second timing advance value.

As shown in block 1030, the apparatus may include means, such as the processing circuitry 505, the communication interface 515 or the like, for causing transmission, using the third timing advance value, towards the second network entity, of one or more communications.

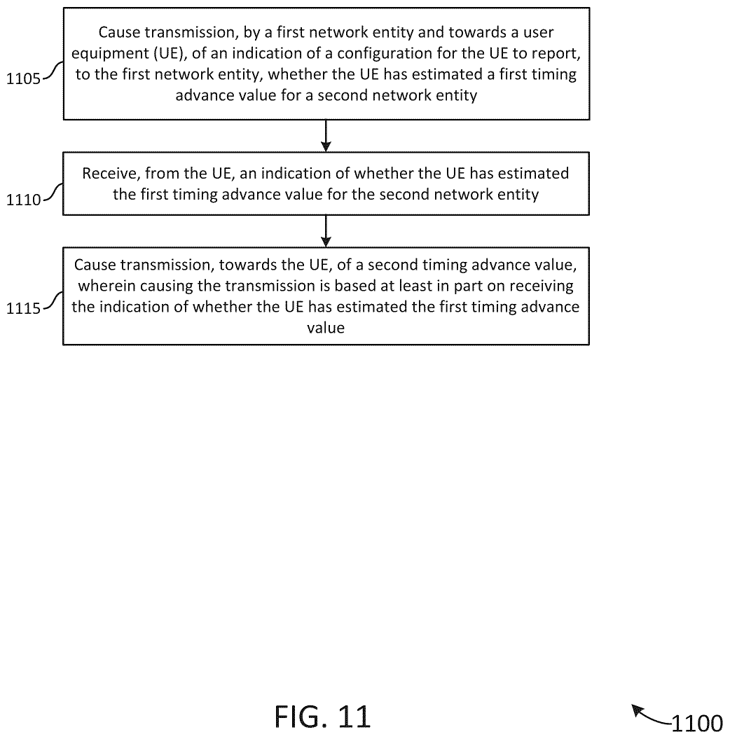

FIG. 11 illustrates an example of a flowchart 1100 of the operations performed by an apparatus, such as may be embodied by a UE 105, a base station 110 or the like, as described with reference to FIGS. 1-7.

As shown in block 1105, the apparatus may include means, such as the processing circuitry 505, the communication interface 515 or the like, for causing transmission, by a first network entity and towards a user equipment (UE), of an indication of a configuration for the UE to report, to the first network entity, whether the UE has estimated a first timing advance value for a second network entity

As shown in block 1110, the apparatus may include means, such as the processing circuitry 505, the communication interface 515 or the like, for receiving, from the UE, an indication of whether the UE has estimated the first timing advance value for the second network entity.

As shown in block 1115, the apparatus may include means, such as the processing circuitry 505, the communication interface 515 or the like, for causing transmission, towards the UE, of a second timing advance value, wherein causing the transmission is based at least in part on receiving the indication of whether the UE has estimated the first timing advance value.

FIGS. 6-11 illustrate flowcharts and signal flow diagrams depicting methods according to an example embodiment. It will be understood that each block or signal and combination of blocks and signals may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by the memory 510 of an apparatus employing an example embodiment and executed by processing circuitry 505. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed is:

1. An apparatus comprising:
at least one processor; and
at least one memory storing instructions that, when executed by the at least one processor, cause the apparatus at least to perform:
receive, at a user equipment (UE), from a first network entity, an indication of a configuration for the UE to report, to the first network entity, an estimate of a first timing advance value for a second network entity;
determine, at the UE, the estimate of the first timing advance value based at least in part on receiving the indication of the configuration;
cause transmission, towards the first network entity, of the estimate of the first timing advance value for the second network entity or a reference signal time difference associated with the estimate of the first timing advance value;
receive, from the first network entity, an indication of an error value associated with the estimate of the first timing advance value for the second network entity;
determine a second timing advance value based at least in part on the estimate of the first timing advance value and the error value; and
cause transmission, using the second timing advance value, towards the second network entity, of one or more communications.

2. The apparatus according to claim 1, wherein the first timing advance value configuration indicates that the UE is to report the estimate of the first timing advance value for the second network entity based at least in part on an availability of the second network entity.

3. The apparatus according to claim 1, wherein the first timing advance value configuration indicates that the UE is to report the estimate of the first timing advance value for the second network entity based at least in part on one or more conditions being satisfied.

4. The apparatus according to claim 3, wherein the one or more conditions comprise one or more of: (i) a signal strength measurement for a signal received from the second network entity being greater than a signal strength measurement for a signal received from the first network entity, (ii) the signal strength measurement for the signal received from the second network entity satisfy a threshold, or (iii) one or more criteria associated with beam quality for the second network entity being satisfied.

5. The apparatus according to claim 1, wherein the first timing advance value configuration indicates that the UE is to report the estimate of the first timing advance value for the second network entity based at least in part on one or more of (i) a change of a beam of the second network entity used for determining the estimate of the first timing advance value or (ii) a change of an SSB of the second network entity used for determining the estimate of the first timing advance value.

6. The apparatus according to claim 1, wherein the instructions further configure the apparatus to:
cause transmission, towards the first network entity, of information associated with the second network entity, the information comprising one or more of: (i) reference signal information for the second network entity, (ii) an identifier for the second network entity, or (iii) a carrier frequency for communications with the second network entity.

7. The apparatus according to claim 1, wherein receiving the indication of the error value further comprises receiving a medium access control control element (MAC-CE) from the first network entity comprising the indication of the error value.

8. An apparatus comprising:
at least one processor; and
at least one memory storing instructions that, when executed by the at least one processor, cause the apparatus at least to perform:
cause transmission, by a first network entity and towards a user equipment (UE), of an indication of a configuration for the UE to report, to the first network entity, an estimate of a first timing advance value for a second network entity;
receive, from the UE, the estimate of the first timing advance value for the second network entity;
determine, by the first network entity, an error value associated with the estimate of the first timing advance value, wherein the determining is based at least in part receiving the estimate of the first timing advance value; and
cause transmission, towards the UE, of an indication of the error value associated with the estimate of the first timing advance value for the second network entity.

9. The apparatus according to claim 8, wherein the instructions further configure the apparatus to:
receive, from the second network entity, a second timing advance value, wherein determining the error value based at least in part on a comparison of the first timing advance value and the second timing advance value.

10. The apparatus according to claim 8, wherein the first timing advance value configuration indicates that the UE is to report the estimate of the first timing advance value for the second network entity based at least in part on an availability of the second network entity.

11. The apparatus according to claim 8, wherein the first timing advance value configuration indicates that the UE is to report the estimate of the first timing advance value for the second network entity based at least in part on one or more conditions being satisfied, wherein the one or more conditions comprise one or more of: (i) a signal strength measurement for a signal received from the second network entity being greater than a signal strength measurement for a signal received from the first network entity, (ii) the signal strength measurement for the signal received from the second network entity satisfy a threshold, or (iii) one or more criteria associated with beam quality for the second network entity being satisfied.

12. The apparatus according to claim 8, wherein the instructions further configure the apparatus to:
receive, from the UE, information associated with the second network entity, the information comprising one or more of: (i) reference signal information for the second network entity, (ii) an identifier for the second network entity, or (iii) a carrier frequency for communications with the second network entity.

13. An apparatus comprising:
at least one processor; and
at least one memory storing instructions that, when executed by the at least one processor, cause the apparatus at least to perform:
receive, at a user equipment (UE), from a first network entity, an indication of a configuration for the UE to report, to the first network entity, whether the UE has estimated a first timing advance value for a second network entity;
determine, at the UE, the estimate of the first timing advance value based at least in part on receiving the indication of the configuration;
cause transmission, towards the first network entity, of an indication of whether the UE has estimated the first timing advance value for the second network entity;
receive, from the first network entity, a second timing advance value;
determine a third timing advance value based at least in part on the first timing advance value and the second timing advance value; and
cause transmission, using the third timing advance value, towards the second network entity, of one or more communications.

14. The apparatus according to claim 13, wherein the instructions further configure the apparatus to:
determine an error value based at least in part on comparing the first timing advance value with the second timing advance value, wherein the UE determines the third timing advance value based at least in part on the error value.

15. The apparatus according to claim 13, wherein the first timing advance value configuration further indicates that the UE is to report an identifier of the second network entity to the first network entity in an instance in which the UE has estimated the first timing advance value for the second network entity.

16. The apparatus according to any of claim 16 to claim 19, wherein the configuration indicates that the UE is to report whether the UE has estimated a first timing advance value first timing advance value for the second network entity based at least in part on one or more conditions being satisfied, wherein the one or more conditions comprise one or more of: (i) a signal strength measurement for a signal received from the second network entity being greater than a signal strength measurement for a signal received from the first network entity, (ii) the signal strength measurement for the signal received from the second network entity satisfy a threshold, or (iii) one or more criteria associated with beam quality for the second network entity being satisfied.

17. An apparatus comprising:
at least one processor; and
at least one memory storing instructions that, when executed by the at least one processor, cause the apparatus at least to perform:
cause transmission, by a first network entity and towards a user equipment (UE), of an indication of a configuration for the UE to report, to the first network entity, whether the UE has estimated a first timing advance value for a second network entity;
receive, from the UE, an indication of whether the UE has estimated the first timing advance value for the second network entity; and
cause transmission, towards the UE, of a second timing advance value, wherein causing the transmission is based at least in part on receiving the indication of whether the UE has estimated the first timing advance value.

18. The apparatus according to claim 17, wherein the first timing advance value configuration further indicates that the UE is to report an identifier of the second network entity to the first network entity in an instance in which the UE has estimated the first timing advance value for the second network entity.

19. The apparatus according to claim 17, wherein the configuration indicates that the UE is to report whether the UE has estimated a first timing advance value first timing advance value for the second network entity based at least in part on one or more of (i) a change of a beam of the second network entity used for determining the estimate of the first timing advance value or (ii) a change of an SSB of the second network entity used for determining the estimate of the first timing advance value.

20. The apparatus according to claim 17, wherein the instructions further configure the apparatus to:
receive, from the UE, information associated with the second network entity, the information comprising one or more of: (i) reference signal information for the second network entity, (ii) an identifier for the second network entity, or (iii) a carrier frequency for communications with the second network entity.
